(19) United States
(12) Patent Application Publication
(10) Pub. No.: US 2002/0049831 A1
(43) Pub. Date: Apr. 25, 2002

(54) System for generating a web document

(75) Inventors: Michael Gary Platner, Pompano Beach, FL (US); Jeffrey Robert Renza, Margate, FL (US); John-Brian Vyncent, Boca Raton, FL (US)

Correspondence Address: EDWARD O. KRUESSER, BROBECK PHLEGER & HARRISON, 12390 EL CAMINO REAL, SAN DIEGO, CA, 92130, US

(73) Assignee: Lifefiles.com,Inc.

(21) Appl. No.: 09/943,891

(22) Filed: Aug. 30, 2001

Related U.S. Application Data
(60) Provisional application No. 60/229,955, filed on Sep. 1, 2000.

(51) Int. Cl. G06F 15/16

(52) U.S. Cl. 709/218; 707/513; 709/219

(57) ABSTRACT

A system for generating a web document includes a prearranged web document capable of being displayed using a web browser, a database containing preprogrammed information, and a form document. A user employs the form document to select user variables from the preprogrammed information. Once the user variables are selected, a user web document is automatically generated based on the desired user variables. The user web document is capable of being displayed on a computer using the web browser and is electronically linked to the prearranged web document.

### RELATED APPLICATIONS

This application claims priority from U.S. Provisional Patent Application No. 60/229,955 to Platner, et al., entitled “System for Populating a Database,” filed Sep. 1, 2000, which is incorporated herein by reference in its entirety.

### FIELD OF THE INVENTION

The present invention relates to web documents generated and accessed over a system of networked computers, such as the Internet.

### BACKGROUND OF THE INVENTION

Computer systems in general are known. A typical system comprises a computer, keyboard, mouse, and a monitor. Additionally, the computer comprises a central processing unit (“CPU”) and random access memory (“RAM”) and allows various software programs to be used. Further, the computer might comprise a modem, an Ethernet card or other similar device for connecting to a system of networked computers, such as the Internet.

The Internet provides a useful technique for making information available to a variety of individuals each of whom may be located at a variety of different locations. Indeed, within the vast Internet environment, individuals can access information tools from remote locations.

The Internet, which originally came about in the late 1960s, is a computer network made up of many smaller networks spanning the entire globe. The host computers or networks of computers on the Internet allow public or private access to databases containing information in numerous areas of expertise. Hosts can be sponsored by a wide range of entities including, for example, universities, government organizations, commercial enterprises and individuals.

Internet information is made available to the public through servers running on an Internet host. The servers make documents or other files available to those accessing the host site. Such files can be stored in databases and on storage media such as, for example, optical or magnetic storage devices, preferably local to the host.

Networking protocols can be used to facilitate communications between the host and a requesting client. TCP/IP (“Transmission Control Protocol/Internet Protocol”) is one such networking protocol. Computers on a TCP/IP network utilize unique identification (“ID”) codes, allowing each computer or host on the Internet to be uniquely identified. Such codes can include an IP (“Internet Protocol”) number or address, and corresponding network and computer names.

Created in 1991, the World-Wide Web (“web”, or “WWW”) provides access to information on the Internet, allowing a user to navigate Internet resources intuitively, without IP addresses or other specialized knowledge. The web comprises hundreds of thousands of interconnected “pages”, or documents, which can be displayed on a user's computer monitor. The web pages are provided by hosts running special servers. Software that runs these web servers is relatively simple and is available on a wide range of computer platforms including personal computers (“PCs”). Equally available is web browser software, used to display web pages as well as traditional non-web files on the user's system.

Recent years have been marked by a societal and technological revolution driven by the convergence of the data processing and data storage industry with consumers via the Internet. A major one of these technologies is the Internet-related distribution of documents, media and programs. With the expansion that has occurred, businesses and consumers have direct access to a wide range of documents, media and even computer programs.

The web is based on the concept of hypertext and a transfer method known as “HTTP” (“Hypertext Transfer Protocol”). HTTP is designed to run primarily over TCP/IP and uses the standard Internet setup, where a server issues the data and a client displays or processes it. TCP/IP is the set of communications protocols used to connect hosts on the Internet. TCP/IP uses several protocols, the two main ones being TCP and IP. TCP/IP is built into UNIX operating systems and is used by the Internet, making it the de facto standard for transmitting data over networks. Even network operating systems that have their own protocols, such as NETWARE™ (Novell, Inc.), also support TCP/IP.

One format for information transfer is to create documents using HTML. HTML pages are made up of standard text as well as formatting codes indicating how to display the page. The browser reads these codes to display the page. Each web page may contain pictures and sounds in addition to text. Associated with certain text, pictures or sounds are connections, known as hypertext links, to other pages within the same server or even on other computers within the Internet. For example, links may appear as underlined or highlighted words or phrases. Each link is directed to a web page by using a special name called a URL (“Uniform Resource Locator”). URLs enable the browser to go directly to the associated resource, even if it is on another web server. Current, widely implemented design and implementation processes for designing a web page require any change to the web page to be performed by a graphic artist, design engineers, or the like, to compose the site and then have it made available or published via the Internet. Once published, every change to the web page generally requires the same cycle of development and implementation work.

However, end users desire to automatically and/or dynamically create and/or modify a web document easily and efficiently while on a publicly accessible network. For example, end users that are not particularly familiar with programming a web document want to be able to easily create and/or modify a web document. Additionally, end users desire to automatically convert text from one language to another language. Currently, text on a web page is not automatically translated. Instead, for example, the web site may allow a user to select a specific region of the world or a particular language. The user is then taken to web documents in that language. However, the web documents in the different languages have been manually translated into different languages by groups of programmers. The design of the web document is static, e.g., the end user is unable to modify the design of the web page or the content automatically for different languages.

Accordingly, there is a long felt need to provide a system on a publicly accessible network which allows an end user to automatically and/or dynamically create and/or modify a displayed web document.

### SUMMARY OF THE INVENTION

The present invention relates to methods and systems for generating and modifying web documents, such as web pages, including information contained in web documents, such as textual comments, audio or digital image files. Particularly disclosed is a system and method for providing a central storage and access location on a network, such as a network server and/or database, wherein web documents, such as web pages or HTML documents, are generated and/or modified by an end user based on variables that are selected by the end user. It is an aspect of this invention to also provide a system which determines the character set of an end user's computer and automatically and/or dynamically prepare web documents for display based on the determined character set. For example, the character sets can be of different languages.

One embodiment of the present invention comprises a method for automatically generating a web document comprising: providing at least one prearranged web document wherein the at least one prearranged web document is capable of being displayed on a computer using a web browser; providing a database with preprogrammed information; providing a form document; selecting user variables wherein the user variables are selected from the preprogrammed information using the form document; and automatically generating a user web document adapted for display on the computer, wherein the user web document is generated based on the desired user variables, the user web document being electronically linked to the prearranged web document.

Another embodiment of the present invention comprises a method for dynamically generating a web document comprising: providing a database with preprogrammed information; providing a form document; selecting desired user variables, wherein the desired user variables are selected from the preprogrammed information using the form document; and automatically generating a user web document based on the desired user variables.

Another embodiment of the present invention comprises a method for dynamically generating a web document in a second language comprising: providing a database with preprogrammed information; selecting desired user variables in a first language wherein the desired user variables are selected from the preprogrammed information; and automatically generating a user web document, wherein the user web document is generated in a second language based on the desired user variables.

Another embodiment of the present invention comprises a system that automatically generates a web document comprising: a database with preprogrammed information; a form document; user variables wherein the user variables are selected from the preprogrammed information using the form document; and a user web document that is capable of being displayed on a computer using a web browser, wherein the user web document is automatically generated based on the desired user variables.

A technical advantage of an embodiment of the present invention is that web documents can be generated quickly and efficiently in real time, by an end user that is not necessary familiar with the requirements of programming in a Markup Language. Additionally, web documents can be generated in multiple languages without having to manually translate the web documents.

Other aspects, embodiments, and technical advantages of the present invention are set forth in or will be apparent from drawings, claims, and the disclosure of the invention, or may be learned from the practice of the invention. Such other aspects, embodiments, and technical advantages shall be deemed to be a part of the invention as if they were disclosed.

### BRIEF DESCRIPTION OF THE DRAWINGS

Reference is now made to the following description and the accompanying drawings, in which:

FIG. 1 is a schematic system illustrating a portion of a computer, including a CPU, conventional memory, and communications hardware in which the present invention may be embodied;

FIG. 2 is a schematic diagram illustrating an embodiment of the present invention;

FIG. 3 is a flowchart illustrating an embodiment of the present invention;

FIG. 4 illustrates an example of a form document according to an embodiment of the present invention;

FIG. 5 illustrates another example of a form document according to an embodiment of the present invention;

FIG. 6 is a schematic diagram illustrating an embodiment of the present invention to translate a web document into a different language;

FIG. 7 illustrates an example of a form document according to an embodiment of the present invention; and

FIG. 8 illustrates an example of a user web document according to an embodiment of the present invention.

### DETAILED DESCRIPTION OF AN ILLUSTRATIVE EMBODIMENT

The following detailed description refers to the accompanying drawings. Other embodiments are possible and modifications may be made to the embodiments without departing from the spirit and scope of the invention. Therefore, the following detailed description is not meant to limit the invention. Rather the scope of the invention is defined by the appended claims.

For convenience in the ensuing description, the following explanations of terms are adopted. However, these explanations are intended to be exemplary only. They are not intended to limit the terms as they are described or referred to throughout the specification. Rather these explanations are meant to include any additional aspects and/or examples of the terms as described and claimed herein.

“Web document(s)” or “electronic document(s)” refers to Internet, on-line network documents, or any document or information that is capable of being transmitted over a system of networked computers, which can be read on a computer terminal via a web browser. Preferably web documents are read and/or viewed from a remotely located computer terminal which accesses the information via a network and/or the Internet. Web documents include, text messages, text letters, comments, documents such as web pages, HTML pages including pictures, text and hypertext, audio files, video files, other on-line media content such as FLASH™ (Macromedia, Inc) documents, photographs, and the like. Moreover, electronic documents or information also includes Markup Language (“ML”) pages, where the mark up language may be read using Internet browsers and comprises information generally viewed on a standard HTML page, and can also have embedded software programs which run via remote access to the ML document. ML documents include documents written in the EXtensible Markup Language (“XML”), Active Server Page (“ASP”) (Microsoft Corporation), Server-Parsed HTML (“SHTML”), the EXtensible HyperText Markup Language (“XHTML”), the Wireless Markup Language (“WML”), the Compact HyperText Markup Language (“cHTML”), the Handheld Device Markup Language (“HDML”), JAVA® (Sun Microsystems, Inc.) programs, applets and the like. A “user web document” is a web document that has been created based on information selected by an end user.

A “computer,” as used herein, includes any general-purpose machine that processes data according to a set of instructions that is stored internally either temporarily or permanently, including, but not limited to, a general purpose computer, workstation, laptop computer, personal computer, set top box, web access device (such as WEB TV™ (Microsoft Corporation)), television interfaces, kiosks, cable television, satellite television, broadband network, an electronic viewing or listening device, wireless devices, such as a personal digital assistant (“PDA”), cellular or mobile telephones, an electronic handheld unit for the wireless receipt and/or transmission of data, such as a BLACKBERRY™ (Research In Motion Limited Corporation), or the like.

The “system of networked computers,” as used herein, means any system of interconnected computers such as the Internet, an intranet, a virtual private network (“VPN”), a local area network (“LAN”), a wide area network (“WAN”), and the like. The system of networked computers may be any system of multiple computers that are directly or indirectly interconnected by any type of electronic connection. Further, as used herein, the term “network” refers to any such system of networked computers.

An “end user” or “user” is an individual who accesses the network via a computer terminal. A user can preferably access the network to obtain electronic information and may be able to modify the manner by which the electronic information is displayed. Generally, users will be at least one individual. With regard to the present invention the number of users is not considered a limiting aspect nor is the purpose for accessing the network. In particular, there can be as many users as are capable of accessing the desired electronic information. Because individual access to the Internet increases on a minute by minute basis, all individuals who can gain access to the system of networked computers are potential users.

“Secure manner” or “secured access” refers to providing access to the network in an exclusive, private manner. Such access can be granted to a user by providing a secret password or other method of identification which is entered in order to gain access to the network, such as, for example, biometric information (for example, a fingerprint, voice recognition, or retinal), knowledge based identifying information (for example, a mother's maiden name), or the like. Encryption methods can also be used to provide exclusive access to the network. Encryption methods involve submitting to the network or transmitting from the network in a manner which must be translated by encryption software which is running on both the network computer and the remote computer terminal. Electronic information may also be kept on the network computer terminal storage hard drive and database in a secure manner as a person with permission and/or password access can view the electronic information.

The “funeral industry,” as used herein, means some or all of the services provided by service providers in the fields of funeral services, cemeteries, death counseling, support groups, businesses that provide on-line products for funerals, businesses that provide funeral services, life insurance companies, death care professionals, cremation societies, monument companies, and the like.

“Character set” refers to the language and the symbols used to convey information to a user. Character sets are the letters which are used in a particular language's written expression. It is an embodiment of the present invention to provide a system that recognizes the character set of a user's computer and automatically and/or dynamically generates and/or provides a web document with the correct language characters. For example, an English speaking user would prefer to access a document containing an English language character set.

“Prearranged web document(s)” refers to one or a group of interlinked web document(s) which are prepared by the owner and/or manager of the web site. The web document(s) are prepared in advance and contain information selected by the owner of the web site. In one embodiment, such document(s) contain information relating to services in the funeral industry. Alternatively, the prearranged web documents include information relating to other goods and/or services.

“Set of members” refers to an end user's list of other people who are able to securely access web documents which are modified by the user.

“Electronic connection,” as used herein, is any electronic connection, including connections via hardwire, Ethernet, token ring, modem, digital subscriber line, cable modem, wireless, radio, satellite, and combinations thereof. Such connections may be implemented using copper wire, fiber optics, radio waves, coherent light, or other media.

“Preprogrammed information” or “system populated with information” refers to preprogrammed information within the database from which the end user chooses preferred aspects and/or desired variables for modifying the user web document. Such preprogrammed information is held within the database and categorized and accessed by a computer program which is executed on the central network and/or database server. The preprogrammed information relates to aspects of the user web document that allow the user to customize the user web document via desired variables, such as background color, religious symbols, background music, textual information, location of navigation bars, hypertext links and other like aspects generally found on web documents. The preprogrammed information also relates to services which can be selected by an end user such as funeral home services, mortuary services, floral services, literary suggestions, addresses and telephone numbers. In one embodiment, the preprogrammed information is dynamic, allowing an end user to add more information to the user web document than is currently in the preprogrammed information.

Disclosed herein is a system comprising a database populated with information, such as for example, text information, e.g., a character set, images, the overall design theme and the like. The system allows a user (for example, a funeral home director, a consumer, or the like) to determinate and select a combination of design and content to be automatically and/or dynamically generated, displayed and modified by the server and/or database program. As the design and content information is previously gathered and placed into the database prior to use, the web site is modified automatically and/or dynamically and is displayed immediately after the choices selected by the end user are submitted. In one embodiment, a secure network and database is provided for users and members to place and view electronic information relating to a deceased party, such as obituary information or remembrance information.

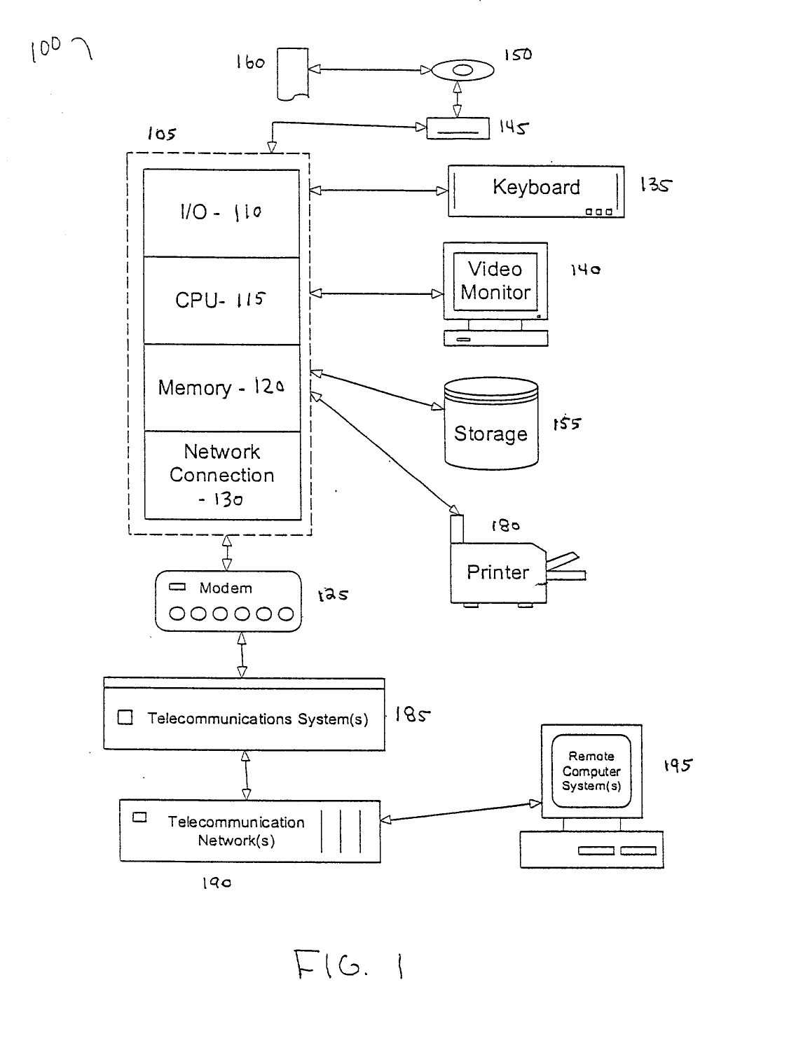

FIG. 1 is a schematic system illustrating a computer 100 used in accordance with an embodiment of the present invention. A user logs onto a system of networked computers, such as by using computer 100. Computer 100 comprises a processor 105 having an input/output (“I/O”) section 110, a CPU 115, a memory section 120, and a network connection 130. Processor 105 is connected to a communications modem 125, a keyboard 135, a display unit 140, a storage disk 155 such as a database, and a CD-ROM or similar unit 145. The CD-ROM unit 145 reads a CD-ROM or similar medium 150, which typically contains programs and data 160. A printer 180 connects to processor 105. A telecommunications system 185 is connected to the system via modem 125 or some other communications device. The telecommunications system 185 allows the system to connect to a telecommunication network 190, such that a user's computer 100 connects to a remote computer system 195. However, the present invention may work on a single or plurality of computers and/or may be locally or remotely operated.

One environment in which embodiments of the present invention may operate is a system of networked computers, wherein general purpose computers, workstations, or personal computers, such as computer 100, are interconnected to remote computer system(s) 195 via communication links of various types, such as via telecommunication network(s) 190. Thus, a user's computer 100 is connected to other computers 195 over a modem, Ethernet connection, or other communications link. Electronic information transmitted from the user or other entities is sent from one such computer system 100 to other similar computer systems 195.

According to an illustrative embodiment, a remote computer accessible network server is a computer which is linked to the Internet. Computer software and hardware may be used to connect the server to the Internet. The server is considered to be remotely accessible by a personal computer terminal which can be located various distances from the network server and connected to the Internet. Access to the network server by a remote computer is initially made via the World Wide Web based on the URL or IP address provided by a user from a remote computer terminal. Internet browsing software such as NETSCAPE NAVIGATOR® (Netscape Communications Corporation) or MICROSOFT INTERNET EXPLORER™ (Microsoft Corporation) provide a remote user access to the URL or IP address of the network server and the electronic information stored therein.

According to one embodiment, the end user can submit information that is automatically localized to areas within a web document, such as a submitted textual comment, a digital image or a sound file. The information is automatically and/or dynamically placed into the web document, by a computer program that resides on the central network or database server computer. The submitted information in one embodiment is accessible by the user and the set of members, and in one embodiment, not others. The user submits information via a system form or form document, which is a web document that is on the web site and may be connected to the central network database or network servers. The form document contains instructions which inform the user how to make changes to particular categories of the web document, such as, for example, background color, religious preference (e.g., symbols that should appear on the web document), background music, textual comments and textual comment locations. The form document also contains entry spaces which provide an area where the user can place textual information as desired. The information placed in such entry spaces is then entered into the user web document in a predetermined location automatically and/or dynamically by computer software run by the owner and/or operator of the web site hosting the form document. The form document can also be used to create categories within the database as determined by the user, wherein the categories are linked to additional user web documents.

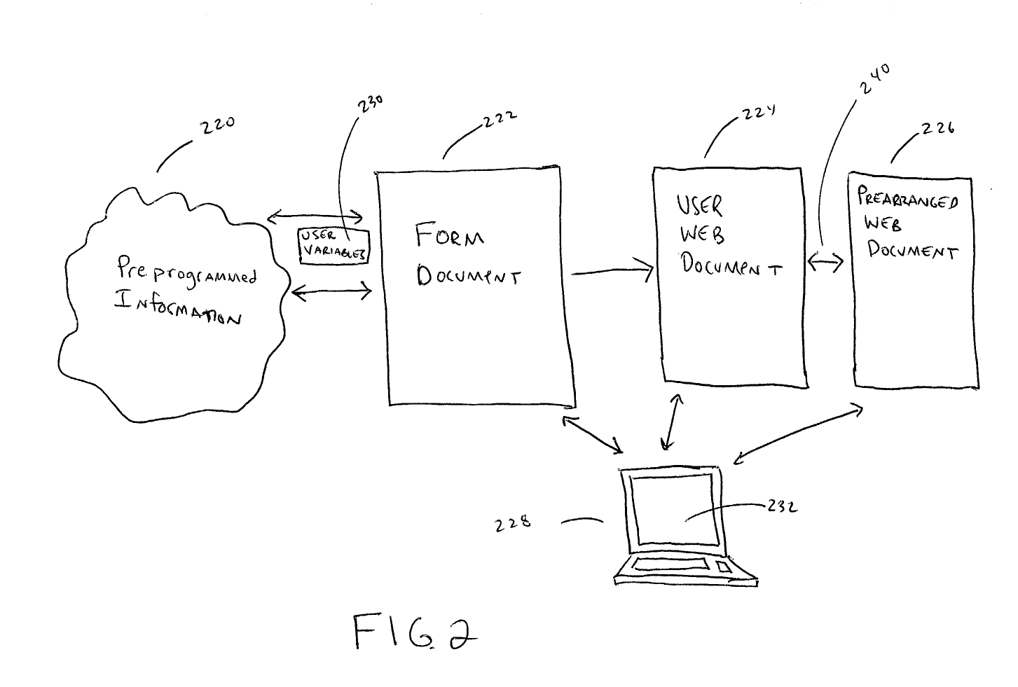

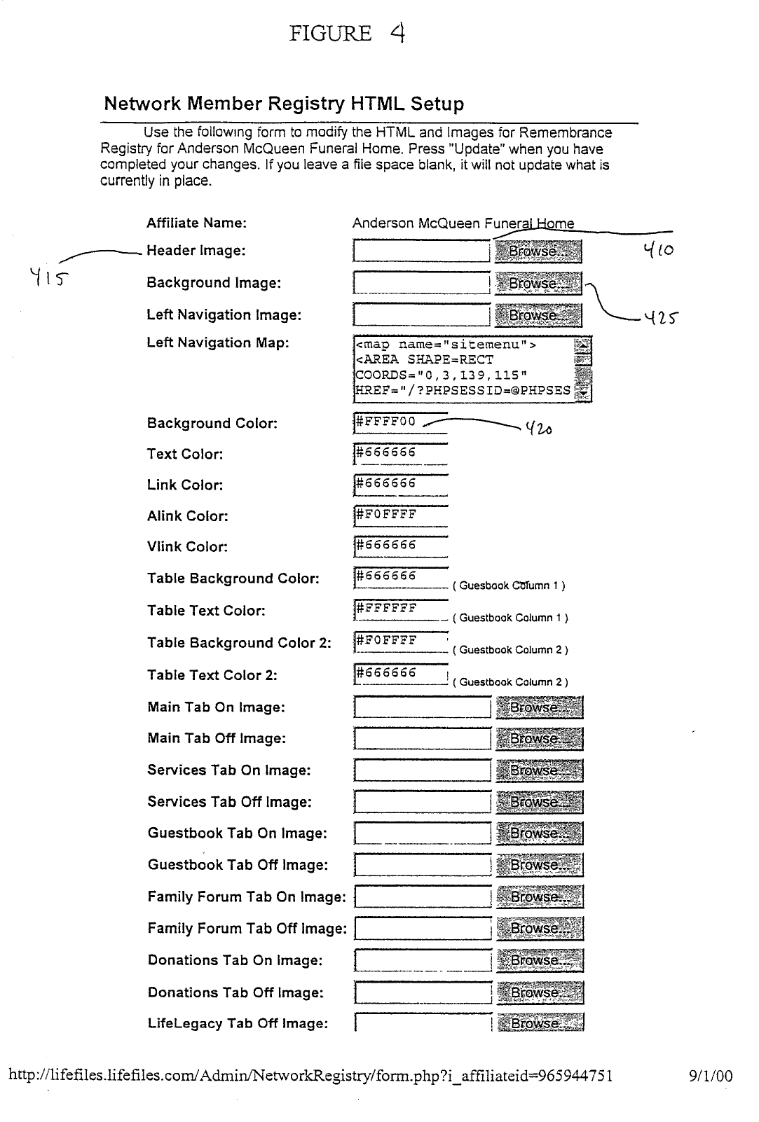

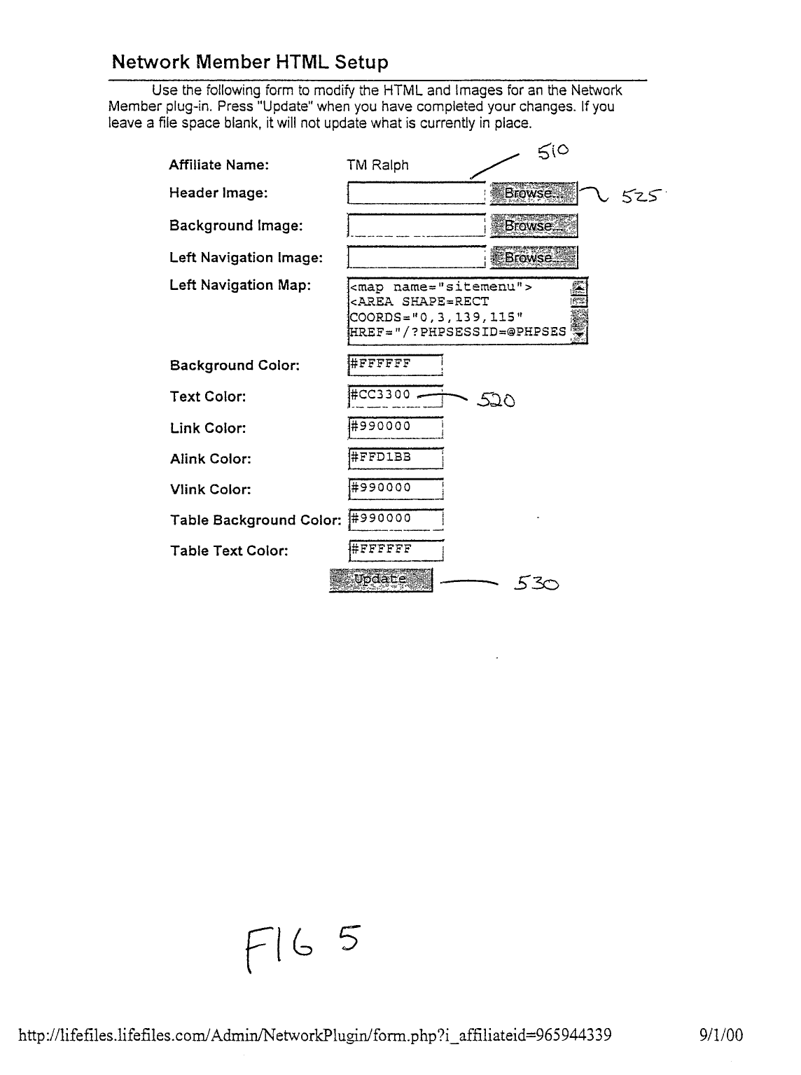

FIG. 2 is a schematic diagram illustrating an embodiment of the present invention. A computer 228 running web browser 232 is used by an end user that desires to generate a user web document. The end user enters a web site that provides a form document 222. The end user selects various desired user variables 230 using form document 222. An example of a form document is shown in FIGS. 4 and 5. The form document serves as template document which allows the user to add desired variables, such that the user creates a user web document that he or she desires. The user variables 230 are part of preprogrammed information 220. Alternatively, user variables 230 may be information entered by the user that is not a part of preprogrammed information 220.

After the end user has selected the desired user variables 230 using form document 222, a user web document 224 is automatically created by computer software running on the network hosting the web site. For example, if the user variables indicated a desire to have a background color of red, a foreground color of blue, and tabs for various additional pages in green, a user web document 224 is created with a background color of red, foreground color of blue, and tabs for the additional pages in green. The user web document 224 is created and is accessible in real time; as soon as it is created it may be accessed and/or viewed by others over the system of networked computers.

Additionally, when the user web document 224 is created, a link 240 to prearranged web documents 226 that exist on the web site is automatically created. The prearranged web documents 226 were previously created, for example, by an owner and/or operator of the web site. The prearranged web documents 226 can comprise multiple web documents or a single web document. The user web document 224 that is created is linked 240 to the prearranged web documents 226. Thus, to an outside viewer, the user web document 224 and prearranged web documents 226 appear to have been created by the same entity, when in reality the documents were likely created by different entities at different times. Computer 228 running web browser 232 can then view the user web document 224 and prearranged web documents 226.

The computer software that is used to create the user web document from the form document can be programmed in PHP Hypertext Preprocessor (“PHP”). Information regarding PHP can be found at “http://www.php.net/,” which is incorporated by reference herein in its entirety. Alternatively, the computer software can be programmed in any other computer language, such that the computer software can create a user web document based on the user's completed form document.

When a user has finished entering the desired information in the form document, the computer software programmed in PHP finds the corresponding information in the preprogrammed information. Alternatively, if the desired information was merely entered by the user, the computer software will use that information. Moreover, the computer software is programmed to indicate where the desired information should be shown on the user web document. For example, the computer software can be programmed to place particular types of items in a particular location on the web document (e.g., place pictures in a certain arrangement on the user web document, place information about the user on the top of the page, or the like).

When the computer software creates the user web document, it creates the code for the user web document that can be displayed using a web browser. In one embodiment, the computer software creates the user web document in HTML, such that the user web document can be read by a web browser and displayed. For example, if a user had selected a background color of yellow, the computer software would create a line of code in HTML for the user web document that would be an instruction to make the background color of the user web document yellow. If the user had indicated on the form document that a picture video, sound, or image file was to be included in the user web document, the computer software would create an instruction in the user web document, in HTML, to include this particular video, sound, or image file. Alternatively, the user web document can be coded in any other ML language.

Additionally, the computer software can also obtain other information to be used in the user web document that was not entered in the form document. For example, based on the user's log-in, the computer software can obtain the name of the user, his or her date of birth, or the like. The information gathered by the software can be a default, where the user can edit this information before accepting it.

Moreover, after the user web document is created, the user can be prompted as to whether the user web document is acceptable. If it is not acceptable, the user can edit the form document to correct the user web document. If the user web document is acceptable, then the user web document would be ready to be accessed over the Internet.

According to an embodiment of the present invention, an end user is provided a system for making modifications to an existing user web document. In a preferred embodiment, but not a limiting aspect of the invention, the user web document contains information relating to a deceased person or animal and is accessible by the set of members. The system comprises a database which is populated with variables which are changed based on user preferences via web documents, which are form documents or system forms. The form documents represent aspects or data entry points for the database program which are provided to the user for manipulation, such aspects may be predetermined by the individual who manages and/or owns the web site. Thus, the user can modify an existing web document by editing the form document. The variables alter aspects of the user web document, such as the background color, the font and/or color of the text, the location of written information relative to the web document. Moreover, the variables can alter information in the user web document, information in the upper left or lower right portion of the document, the location of user submitted pictures, and the character set of the textual information (for example the character set can be English, French, German, Japanese, any other spoken language, or any other language). Accordingly, a user can create or modify a user web document.

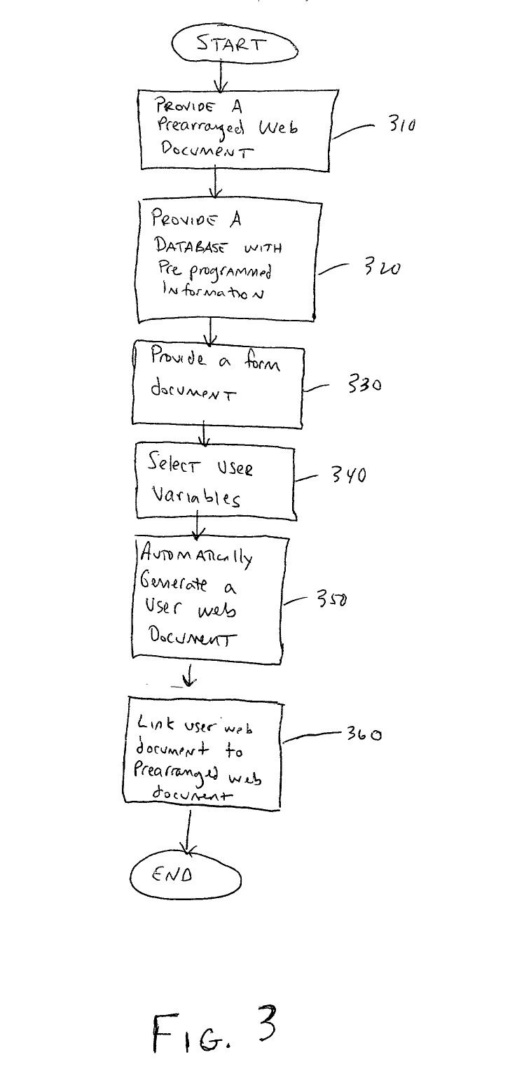

FIG. 3 is a flowchart illustrating an embodiment of the present invention. At 310, a prearranged web document is provided. The prearranged web document may have been created by an owner and/or operator of the web site hosting the prearranged web document.

At 320 a database is provided with preprogrammed information. The preprogrammed information is information that an end user selects when creating the user web document.

At 330, a form document is provided. The form document allows the end user to select user variables. The user variables are part of the preprogrammed information. An example of a form document is shown in FIGS. 4 and 5.

At 340, the user selects user variables he or she desires. These user variables are used to create the user web document.

At 350, the user web document is automatically created based on the user variables, in real time. The user web document comprises the information desired by the user.

At 360, the user web document is automatically linked to the prearranged web document. Also, the user web document is now accessible over a system of networked computers. Accordingly, a visitor of the web site can access the user web document and then, via the link in the user web document, access the prearranged web document.

FIG. 4 illustrates an example of a form document according to an embodiment of the present invention. The form document includes various categories 415 that allow a user to select desired variables. The user enters the selected desired variables in space 410. Alternatively, the user can select to browse 425 for the available variables. When the user uses the browse 425 feature to select the desired variables, an input box that lists the available desirable variables is shown to the user. If a file name is to be selected, such as if a video file, the browse button 425 may bring up an input box that allows the user to select that file. If the user does not fill in a desired choice for a particular space 410, a default choice maybe used, or if a choice is not necessary, no choice is used.

An example of a variable is at 420, wherein background color #FFFF00 is yellow. The code #FFFF00 is a code that is used by HTML to indicate the color. Additionally, #666666 is gray, #F0FFFF is white and green, #FFFFFF is white, and #000000 is black. Alternatively, the user can select any other background color that is available, such as #CC3300 which is brick red, #990000 which is a dark red, #FFD1BB which is red and white, or any other color code. Alternatively, the form document can use other codes, for example, use the word “YELLOW” to signify a yellow color as opposed to #FFFF00. Additionally, in this form document, the user selects other categories, such as Table Text Color, Table Background Color, what the Left Navigation Map states, what the Header Image is, personal information about the user, and the like. If the user web document is to be about a deceased person or animal, the form document may including places to input information about the deceased, the birthday of the deceased, the death date of the deceased, information regarding family members, images relating to the deceased, sound clips relating to the deceased, video clips relating to the deceased, an obituary for the deceased, documents relating to the deceased, or the like.

FIG. 5 illustrates another example of a form document according to an embodiment of the present invention. The user selects the desired variables 520 in space 510, such as by browsing the choice of variables. When the user has finished selecting the variables 520, the user selects the update button 530 and the user web document is automatically generated as described herein.

A feature of an embodiment of the present invention is the ability to implement the “Unicode” (see, e.g., “http://www.unicode.org,” which is incorporated by reference herein in its entirety) format for the data contained in the database. Current web document design is performed by designing and implementing a web site in English or in an English character set, and sending the web site to a web designer or programmer for reformatting and/or redesigning the web site into another language or language character set. The present invention comprises a prepopulated database having existing spoken languages and content, and a system comprising a network executed computer program that determines the native language and/or character set of the user's computer and/or Internet browser which is used to automatically and/or dynamically generate the web document(s) in the determined language.

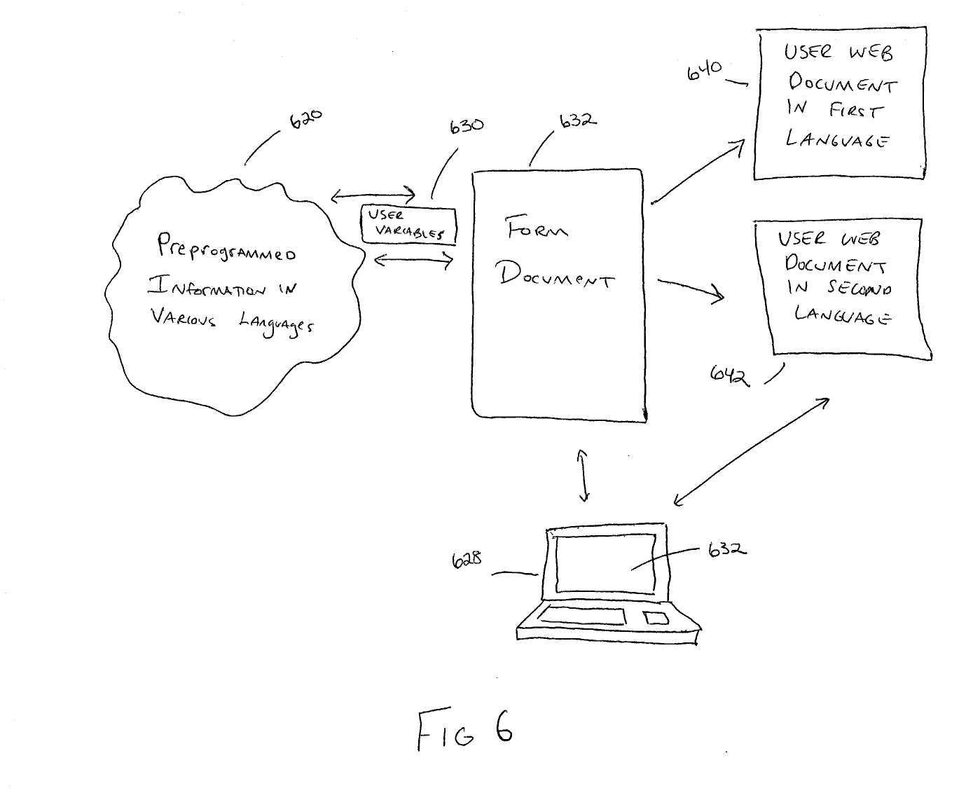

FIG. 6 is a schematic diagram illustrating an embodiment of the present invention to translate a web document into a different language. Preprogrammed information 620 comprises user variable 630. The user variables are stored in various languages, such as spoken languages like English, French, Spanish, and the like.

A user, using a computer, enters a web site using a web browser 632. The web site includes a form document 632. The form document 632 allows the user to select a desired language for the user web document 640 or 642. Alternatively, the web site can automatically detect a default language for the user web document, based on the user's computer or options the user has selected within the user's web browser 632. For example, the settings in the user's computer 630 and/or web browser 632 may indicate a default language. Using MICROSOFT INTERNET EXPLORER™ 4.0, a user can select a language preference under the menu option “VIEW,” selecting “INTERNET OPTIONS,” and selecting “LANGUAGES.”

After a language is selected, the form document will appear in the specified language, prompting the user to select desired variables 630. The desired variables 630 are also in the specified language. After the user has selected the desired variables 630, a user web document 640 is automatically created in the desired language, as described above.

Alternatively, the user variables and form document can be in a first language, and the user web document can be created in a second language. In such an instance, the form document 632 is filled out with the desired user variables 630. The user then selects the desired language or a default desired language is determined (as described herein). Because the user variables 630 exist in the preprogrammed information 620 in various languages, when the user web document is created, the desired variables in the selected language are used. Additionally, as the form document contains form information for the user web document, such form information is also provided in the selected language. If the user decides to now create the user web document in a second language 642, the process of automatically generating the user web document from the form document is repeated using versions of the user variables and form information in the second language. Thus, when the user web document is being automatically created, instead of using the user variables and form information from the first language, the corresponding user variables and form information in the second language are used. Additionally, the process can be repeated for a third language, and so on. Accordingly, user web documents can be automatically created in real time, without the need for the manual translation of such documents into various languages. Further, when a web document is changed, it can be automatically updated for each language without having to manually change a web page for each language.

The computer software that creates the translation of the user web document can function similarly to the computer software that creates the user web document. For example, the software can be in PHP and can automatically create HTML instruction (or some other ML language) for the user web document. However, instead of using the information desired from the form document, the software will use the desired information in the desired language from the preprogrammed information, and then insert such desired information in the desired language as HTML code in the user web document. If the preprogrammed information does not include a translation for the desired information, the software can look up a translation of the desired information in an electronic dictionary or using any other method for electronically and automatically translating information.

Moreover, the user web document can be linked to prearranged web documents as described herein. Alternatively, a user web document can be created in each language for which the user variables 630 have a translation stored in the preprogrammed information 620.

An embodiment of the present invention includes character set information stored in a database. A network and/or database server program determines the native language character set of a user's computer and/or browser and thus the user web document is generated using the determined character set. For example, an English speaking individual writing a document in English can provide the document for public viewing and a public user in Russia can access the document and view the information in the Russian character set; the web documents can be translated as stated above when the web documents are accessed by the public user in Russia. There is no need to create new URL's for each language using the method and system of the present invention. Therefore, end users across the globe can access and/or use the user web documents in any one of the various languages that the web documents can be translated.

According to an embodiment of the present invention, user web documents in the funeral industry are generated and/or used. For example, electronic information from family and friends regarding a deceased may be used. The remote access point may be publicly accessible on the network via an access point on a system of networked computers. Also, the submitted electronic information may be initially accessible by a particular end user related to the deceased through a secure manner to the network. Once the submitted electronic documents are reviewed and accepted by the particular end user, the electronic documents are published or placed on a World Wide Web Internet browser readable page, such as for example an HTML document. The electronic information and the HTML document may be accessible to the public via the Internet in a secure manner, such that the electronic information about the deceased can be easily accessed by family and friends of the deceased.

Alternatively, funeral homes, or other funeral industry providers, can create user web documents for their service and be linked to a large network of funeral services, such as at “http://www.lifefiles.com/,” which is incorporated by reference herein in its entirety. Additionally, family and friends can create a user web document regarding a deceased, with this user web document be linked to the larger network of funeral services. Alternatively still, users in any industry can create user web documents and have them linked to a larger network relating to such industry, using an embodiment of the present invention.

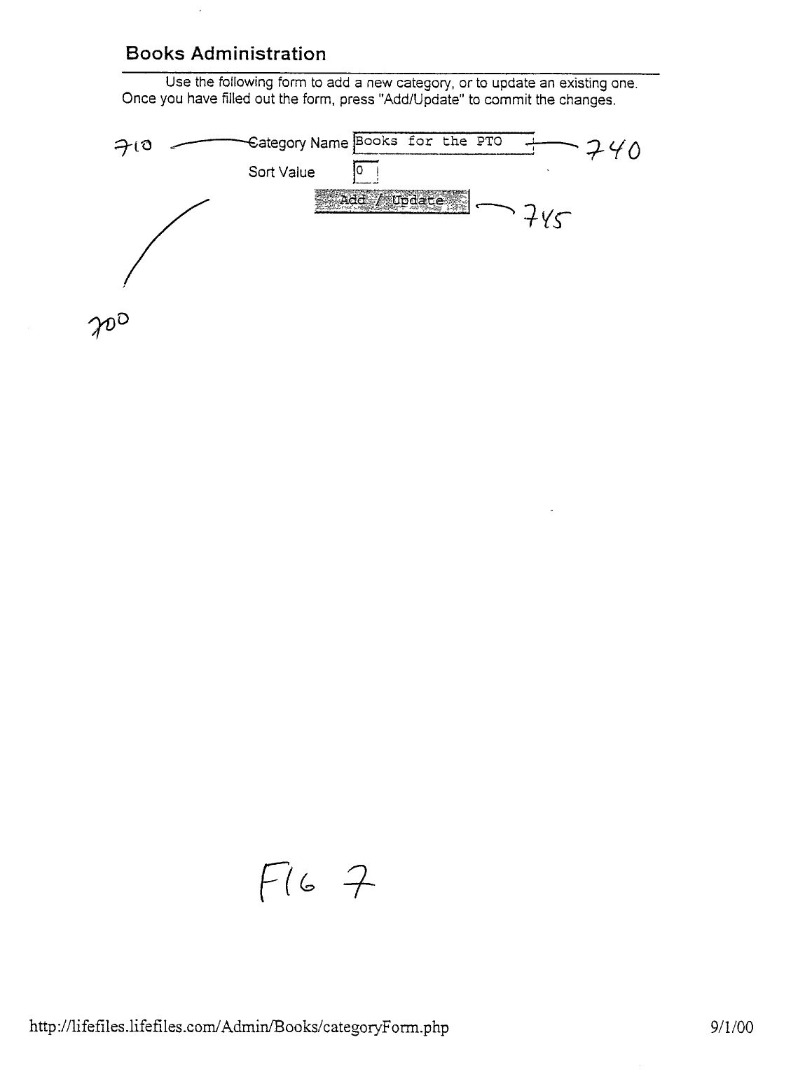

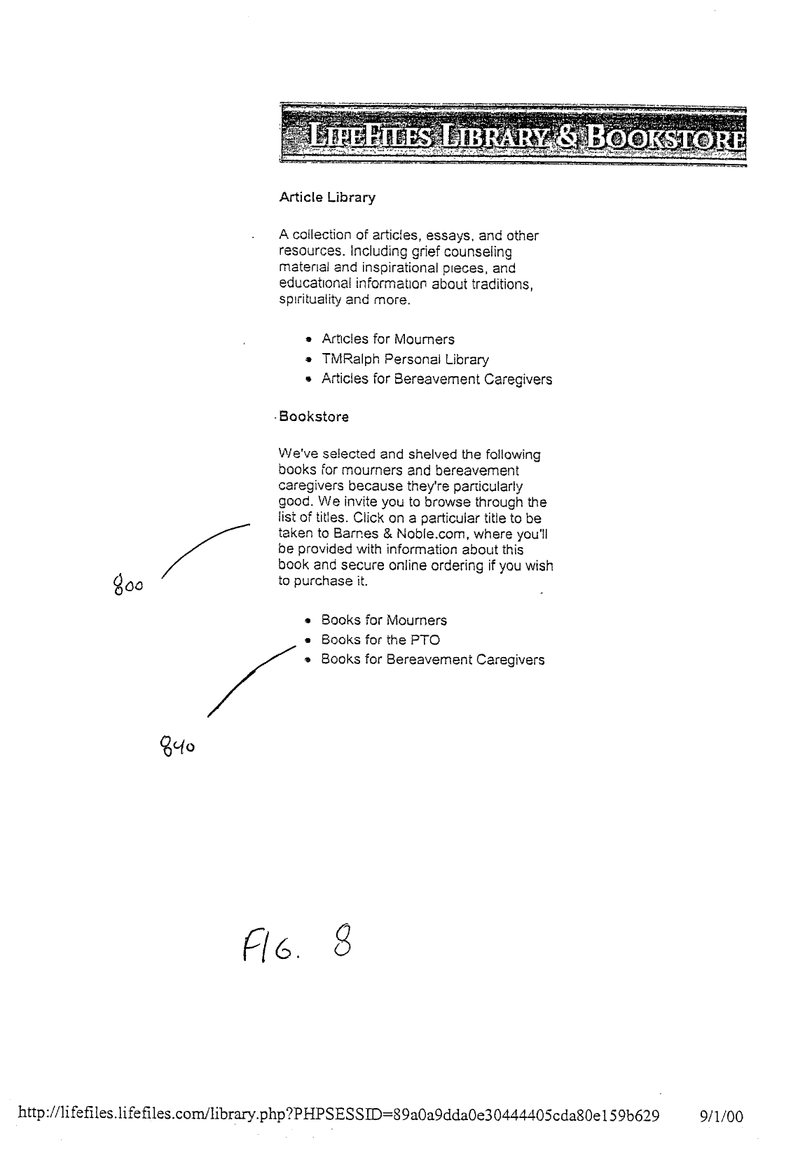

FIG. 7 illustrates an example of a form document according to an embodiment of the present invention. A user inputs a user variable 740 for the category name 710 into a form document 700. The user variable 740 is “Books for the PTO.” After deciding on the user variable, the add/update button 745 is selected. In response to selecting the add/updated button 745, a user web document 800, as shown in FIG. 8, is generated. As shown in FIG. 8, the user variable 840 “Books for the PTO” has been automatically placed on user web document 800 in real time and in a predetermined location.

In an additional embodiment of the present invention, the network server is arranged to allow secure access to generate web documents with the use of a user name and password. A user who desires to generate web documents selects both a user name and a password, or utilizes a user name and password provided by the network server. Additionally, the system may be setup to allow end users to generate documents in a non-secure manner (e.g., without a user name and password).

Even though throughout this disclosure, reference is sometimes made to the funeral industry, aspects of embodiments of the present invention are applicable to all other industries. Such industries include any industry that would benefit from the described present invention, for example the appliance industry or the electronics industry. Additionally, the present invention may be used by any entity that desires for end users to generate a web document.

The steps depicted in flow charts and methods herein may be performed in a different order than as depicted and/or stated. The steps shown are merely exemplary of the order these steps may occur. The steps shown herein may occur in any order that is desired, such that it still performs the goals of the claimed invention. Additionally, steps not desired to be used from the steps shown in the flow charts and methods may be eliminated, such that the goals of the claimed invention are still achieved.

All references, patents and publications described herein are hereby incorporated by reference to the same extent as if each individual reference, patent or publication was specifically and individually indicated to be incorporated by reference.

One skilled in the art would readily appreciate that the present invention is well adapted to carry out the objects and obtain the ends and technical advantages mentioned, as well as those inherent therein. The specific systems and methods described herein as presently representative of preferred embodiments are exemplary and are not intended as limitations on the scope of the invention. Changes therein and other uses will occur to those skilled in the art which are encompassed within the spirit of the invention are defined by the scope of the claims.

It will be readily apparent to one skilled in the art that modifications may be made to the invention disclosed herein without departing from the scope and spirit of the invention. For example, those skilled in the art will recognize that the invention may suitably be practiced using a variety of different access methods such as wireless web devices and are within the general descriptions provided.

The invention illustratively described herein suitably may be practiced in the absence of any element or elements, limitation or limitations which is not specifically disclosed herein. The terms and expressions which have been employed are used as terms of description and not of limitation, and there is not intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In addition, where features or aspects of the invention are described in terms of Markush groups or other grouping of alternatives, those skilled in the art will recognize that the invention is also thereby described in terms of any individual member or subgroup of members of the Markush group or other group. For example, if there are alternatives A, B, and C, all of the following possibilities are included: A separately, B separately, C separately, A and B, A and C, B and C, and A and B and C.

Thus, additional embodiments are within the scope of the invention and within the following claims.

We claim:

1. A method for automatically generating a web document comprising:
providing at least one prearranged web document wherein said at least one prearranged web document is capable of being displayed on a computer using a web browser;
providing a database with preprogrammed information;
providing a form document;
selecting user variables wherein said user variables are selected from said preprogrammed information using said form document; and
automatically generating a user web document adapted for display on said computer, wherein said user web document is generated based on said desired user variables, said user web document being electronically linked to said prearranged web document.

2. The method of claim 1, wherein said at least one prearranged web document comprises a prearranged set of web documents.

3. The method of claim 1, wherein said preprogrammed information comprises character sets.

4. The method of claim 1 wherein said user web document is viewed by said end user over a system of networked computers, wherein said end user is using a web browser to view said user web document.

5. The method of claim 1, wherein said user web document and said prearranged web document both relate to the funeral industry.

6. The method of claim 1, further comprising selecting a language from a choice of languages for said form document, wherein said user web document is automatically generated in said language, and further wherein said language is a spoken language.

7. The method of claim 1, wherein said user web document is accessible in a secure manner by a set of members.

8. The method of claim 1, wherein said user variables are in a first language and said user web document is generated in a second language.

9. The method of claim 8, wherein said first and second languages are spoken languages.

10. The method of claim 8, further comprising automatically determining said second language from said computer or said web browser.

11. The method of claim 1, wherein said step of automatically generating a user web document comprises automatically generating a user web document using computer software programmed in PHP.

12. A method for dynamically generating a web document comprising:
providing a database with preprogrammed information;
providing a form document;
selecting desired user variables, wherein said desired user variables are selected from said preprogrammed information using said form document; and
automatically generating a user web document based on said desired user variables.

13. The method of claim 12 further comprising sending said user web document over a system of networked computers to a user.

14. The method of claim 12, wherein said user web document and said prearranged web document both relate to the funeral industry.

15. The method of claim 12, further comprising selecting a language from a choice of languages for said form document, wherein said user web document is automatically generated in said language.

16. The method of claim 15, wherein said language is a spoken language.

17. The method of claim 15, further comprising automatically determining said language from a computer used by a user or a web browser used by said user.

18. The method of claim 12, wherein said step of automatically generating a user web document comprises automatically generating a user web document using computer software programmed in PHP.

19. A method for dynamically generating a web document in a second language comprising:
providing a database with preprogrammed information;
selecting desired user variables in a first language wherein said desired user variables are selected from said preprogrammed information; and
automatically generating a user web document, wherein said user web document is generated in a second language based on said desired user variables.

20. The method of claim 19, further comprising:
determining a character set from a computer of said user; and
determining said second language based on said character set.

21. The method of claim 19, wherein said first and second languages are spoken languages.

22. The method of claim 19, wherein said user web document relates to the funeral industry.

23. The method of claim 19, further comprising selecting said desired user variables using a form document.

24. The method of claim 19, wherein said step of automatically generating a user web document comprises automatically generating a user web document using computer software programmed in PHP.

25. The method of claim 19, wherein said second language is automatically determined based a web browser used by said user.

26. A system that automatically generates a web document comprising:
a database with preprogrammed information;
a form document;
user variables wherein said user variables are selected from said preprogrammed information using said form document; and
a user web document that is capable of being displayed on a computer using a web browser, wherein said user web document is automatically generated based on said desired user variables.

27. The system of claim 26, further comprising at least one prearranged web document, wherein said at least one prearranged web document is capable of being displayed using a web browser, and further wherein said user web document is electronically linked to said prearranged web document.

28. The system of claim 27, wherein said at least one prearranged web document comprises a prearranged set of web documents.

29. The system of claim 27, wherein said prearranged web document and said user web document are viewed over a system of networked computers, wherein said system of networked computers is the Internet.

30. The system of claim 26, wherein said user web document relates to the funeral industry.

31. The system of claim 26, further comprising a desired language that is selected from a choice of languages for said form document, and said user web document is automatically generated in said desired language.

32. The system of claim 31, wherein said language is a spoken language.

33. The system of claim 26, wherein said user variables are in a first language and said user web document is generated in a second language.

34. The system of claim 33, wherein said first and second languages are spoken languages.

35. The system of claim 26, farther comprising computer software programmed in PHP, wherein said computer software automatically generates said user web document.
